(19) United States
(12) Patent Application Publication
(10) Pub. No.: US 2026/0161629 A1
(43) Pub. Date: Jun. 11, 2026

(54) Real-time reconciliation of data streams

(71) Applicant: LETSKIPP LTD., Herzlia (IL)

(72) Inventors: Chanan Lavi, Binyamina (IL); Nir Levy, Herzliya (IL); Inbal Singer, Kfar Saba (IL); Ofek Bashan, Netanya (IL)

(21) Appl. No.: 18/969,336

(22) Filed: Dec. 5, 2024

(51) Int. Cl. G06F 16/23; G06F 16/245

(52) U.S. Cl. CPC G06F 16/2322; G06F 16/245

(57) ABSTRACT

A first stream of first data records, each including one or more first values describing an event, and a second stream of second data records, each including one or more second values describing an event, are received from respective data sources. Each first data record is stored in an in-memory database with a timestamp. For each second data record, the in-memory database is queried for a matching first data record that likely describes the same event as does the second data record, by virtue of the timestamp of the matching first data record being later than a predefined threshold time, and at least some of the second values in the second data record matching corresponding first values in the matching first data record. An output is communicated based on a combination of the second values in the second data record with the first values in the matching first data record.

### FIELD OF EMBODIMENTS OF THE INVENTION

Embodiments of the present invention are related to the field of computing, and particularly to real-time data processing.

### BACKGROUND

Real-time data processing involves the continuous input, processing, and output of data with minimal latency, allowing for immediate insights and actions.

### SUMMARY

There is provided, in accordance with some embodiments of the present invention, a method for use with a first data source that generates a first stream of first data records, each of which includes one or more first values describing a respective one of multiple events, and a second data source that generates a second stream of second data records, each of which includes one or more second values describing a respective one of the events, at least some of the second values corresponding to corresponding ones of the first values by virtue of describing the same type of data as do the corresponding ones of the first values. The method includes receiving, by a processor, the first stream of first data records from the first data source and the second stream of second data records from the second data source. The method further includes, in response to receiving each of the first data records, storing the first data record in an in-memory database that associates a timestamp with the first data record. The method further includes, in response to receiving each of the second data records, querying the in-memory database for a matching first data record that likely describes the same one of the events as does the second data record, by virtue of the timestamp of the matching first data record being later than a predefined threshold time, and at least some of the corresponding second values in the second data record matching the corresponding ones of the first values in the matching first data record. The method further includes, and provided the querying returns the matching first data record, communicating an output based on a combination of the second values in the second data record with the first values in the matching first data record.

In some embodiments, querying the in-memory database includes querying the in-memory database based on a variable having different settings indicating which of the corresponding second values in the second data record need to match the corresponding ones of the first values in the matching first data record.

In some embodiments, the predefined threshold time is t - s, t being a time at which the in-memory database is queried for the matching first data record, and s being a variable.

In some embodiments, the output includes a recommended action in response to the event based on which the second data record and the matching first data record were likely generated.

In some embodiments, communicating the output includes communicating the output to the first data source and/or to the second data source.

In some embodiments, the output includes an enriched data record combining the second values in the second data record with the first values in the matching first data record.

In some embodiments,
the in-memory database includes a key-value database,
storing the first data record in the in-memory database includes:
   computing a first key from the corresponding ones of the first values in the first data record; and
   storing at least some of the first values in the first data record, in association with the first key, in the key-value database, and
querying the in-memory database includes:
   computing a second key from the corresponding second values in the second data record; and
   querying the key-value database for the second key.

In some embodiments, the key-value database includes a sorted set in which the first data records are sorted by the timestamp.

In some embodiments, the method further includes, in response to the querying returning multiple matching first data records, refraining from communicating the output.

In some embodiments, the method further includes, in response to the querying not returning the matching first data record, re-querying the in-memory database for the matching first data record, at least once, after a predefined duration.

In some embodiments, the method further includes setting a maximum number of re-queries for the matching first data record as a decreasing function of a geographic distance between the processor and a destination to which the output is communicated.

There is further provided, in accordance with some embodiments of the present invention, a computer software product for use with a first data source that generates a first stream of first data records, each of which includes one or more first values describing a respective one of multiple events, and a second data source that generates a second stream of second data records, each of which includes one or more second values describing a respective one of the events, at least some of the second values corresponding to corresponding ones of the first values by virtue of describing the same type of data as do the corresponding ones of the first values, the computer software product including a tangible non-transitory computer-readable medium in which program instructions are stored. The instructions, when read by a processor, cause the processor to receive the first stream of first data records from the first data source and the second stream of second data records from the second data source. The instructions further cause the processor to, in response to receiving each of the first data records, store the first data record in an in-memory database that associates a timestamp with the first data record. The instructions further cause the processor to, in response to receiving each of the second data records, query the in-memory database for a matching first data record that likely describes the same one of the events as does the second data record, by virtue of the timestamp of the matching first data record being later than a predefined threshold time, and at least some of the corresponding second values in the second data record matching the corresponding ones of the first values in the matching first data record. The instructions further cause the processor to communicate an output based on a combination of the second values in the second data record with the first values in the matching first data record, provided the querying returns the matching first data record.

There is further provided, in accordance with some embodiments of the present invention, a system for use with a first data source that generates a first stream of first data records, each of which includes one or more first values describing a respective one of multiple events, and a second data source that generates a second stream of second data records, each of which includes one or more second values describing a respective one of the events, at least some of the second values corresponding to corresponding ones of the first values by virtue of describing the same type of data as do the corresponding ones of the first values. The system includes a communication interface and a processor. The processor is configured to receive, via the communication interface, the first stream of first data records from the first data source and the second stream of second data records from the second data source. The processor is further configured to, in response to receiving each of the first data records, store the first data record in an in-memory database that associates a timestamp with the first data record. The processor is further configured to, in response to receiving each of the second data records, query the in-memory database for a matching first data record that likely describes the same one of the events as does the second data record, by virtue of the timestamp of the matching first data record being later than a predefined threshold time, and at least some of the corresponding second values in the second data record matching the corresponding ones of the first values in the matching first data record. The processor is further configured to communicate an output based on a combination of the second values in the second data record with the first values in the matching first data record, provided the querying returns the matching first data record.

The present invention will be more fully understood from the following detailed description of embodiments thereof, taken together with the drawings, in which:

### BRIEF DESCRIPTION OF THE DRAWINGS

FIG. 1 is a schematic illustration of a system for real-time reconciliation of data records from multiple data sources, in accordance with some embodiments of the present invention;

FIG. 2 and FIG. 3 are flow diagrams for methods for real-time reconciliation of data records from multiple data sources, in accordance with some embodiments of the present invention; and

FIG. 4 is a schematic illustration of an in-memory database in use, in accordance with some embodiments of the present invention.

### DETAILED DESCRIPTION

### Overview

A challenge addressed by embodiments of the present invention is the real-time reconciliation of parallel streams of data generated by multiple data sources. In particular, embodiments of the present invention address a scenario in which two data sources generate respective streams of data records describing a sequence of events, but (i) the data records do not include event identifiers, or include different types of event identifiers that cannot be mapped to one another, (ii) the data records do not include the precise times at which the events occurred, (iii) the streams are received with different latencies, and/or (iv) the streams include different subsets of the events. In such a scenario, it may be challenging to match pairs of data records describing the same event, particularly in real-time.

To address this challenge, embodiments of the present invention store the data records of one stream in an in-memory database that associates respective timestamps with the data records. For each data record of the other stream, the database is queried for a matching data record. A matching data record is one whose timestamp is later than a predefined threshold time, which is typically set to be a number of seconds (or milliseconds) earlier than the time of the query, and which matches the other data record with respect to some of the data contained therein. Typically, a key-value database, which provides fast querying, is used for the in-memory database.

Embodiments of the present invention are applicable to cybersecurity applications, financial applications, social-media analytics, and many other applications.

### System Description

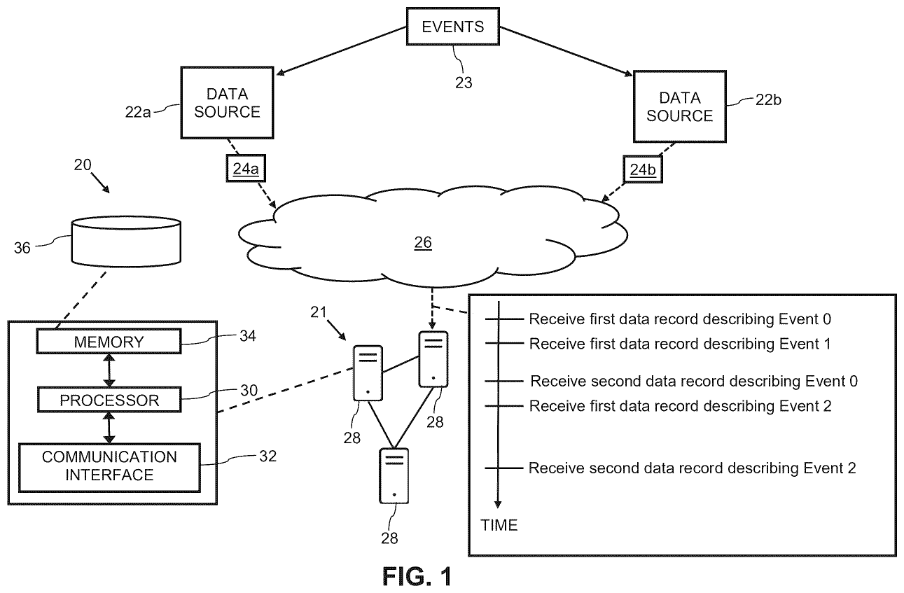

Reference is initially made to FIG. 1, which is a schematic illustration of a system 20 for real-time reconciliation of data records from multiple data sources, in accordance with some embodiments of the present invention.

System 20 comprises at least one processor 30 configured to perform the functionality described below. For example, in some embodiments, system 20 comprises a single processor 30 belonging to a server 28. Alternatively, for example, system 20 comprises a cooperatively networked or clustered set of processors 30 belonging to multiple servers 28, such as multiple servers in a cloud computing platform 21. For ease of description, the present specification refers mostly to “processor” in the singular, with the understanding that in the context of the present application, including the claims, the scope of this term includes multiple processors configured to cooperatively perform the functionality described below.

FIG. 1 depicts a first data source 22a generating a first stream of first data records 24a and communicating the first stream, over a network 26 (e.g., the Internet), to processor 30. FIG. 1 further depicts a second data source 22b generating a second stream of second data records 24b and communicating the second stream, over network 26, to processor 30. Each first data record 24a includes one or more first values describing a respective one of multiple events 23, and each second data record 24b includes one or more second values describing a respective one of events 23. Processor 30 is configured to receive first data records 24a and second data records 24b and to reconcile the first data records with the second data records, i.e., to match any first and second data records that describe the same event 23, as described in detail below.

Typically, a challenge in performing the reconciliation is that the first and/or second data records do not include event identifiers, or the first and second data records include different types of event identifiers that are not reconcilable with one another. Typically, another challenge is that the first and/or second data records do not include the precise times at which the events occurred. Furthermore, typically, first data source 22a and second data source 22b generate and/or communicate the data records with different latencies. Moreover, typically, some events are recorded only by the first data source, and/or some events are recorded only by the second data source. For example, FIG. 1 shows a hypothetical scenario in which processor 30 receives first data records 24a for three events (Event 0, Event 1, and Event 2), but receives second data records 24b for only two of these events (Event 0 and Event 2), with a greater latency relative to first data records 24a.

However, facilitating the reconciliation is that at least some of the second values correspond to corresponding ones of the first values by virtue of describing the same type of data as do the corresponding ones of the first values.

For example, supposing the events are credit-card transactions, one of the data sources may include the merchants at which the transactions occur, and the other data source may include the financial institutions that provide credit for the transactions. The reconciliation may be facilitated by virtue of both the first and second data records including, for example, the first N digits and/or the last M digits of the credit cards, the currencies of the transactions, and/or the amounts of the transactions.

As another example, supposing the events are possible cybersecurity breaches, the data sources may include two different cybersecurity services. The reconciliation may be facilitated by virtue of both the first and second data records including, for example, the same IDs of the devices associated with the possible breaches.

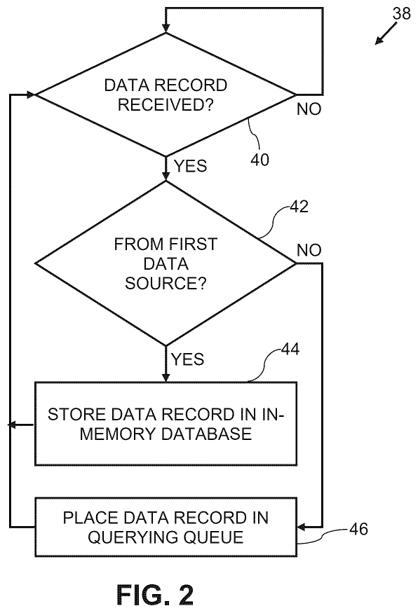

Typically, each server 28 comprises a communication interface 32 and a volatile memory 34, such as a random access memory. Via communication interface 32, the processor of the server receives the streams of data records and communicates the outputs described herein. As further described below with reference to FIG. 2, the processor further stores one of the streams of data records-assumed below to be the first stream-in an in-memory database 36, which resides in memory 34 or is distributed over the respective memories 34 of multiple servers 28.

In some embodiments, the functionality of processor 30 is implemented solely in hardware, e.g., using one or more fixed-function or general-purpose integrated circuits, Application-Specific Integrated Circuits (ASICs), and/or Field-Programmable Gate Arrays (FPGAs). Alternatively, this functionality is implemented at least partly in software. For example, processor 30 may be embodied as a programmed processor comprising, for example, a central processing unit (CPU) and/or a Graphics Processing Unit (GPU). Program code, including software programs, and/or data may be loaded for execution and processing by the CPU and/or GPU. The program code and/or data may be downloaded to the processor in electronic form, over a network, for example. Alternatively or additionally, the program code and/or data may be provided and/or stored on non-transitory tangible media, such as magnetic, optical, or electronic memory. Such program code and/or data, when provided to the processor, produce a machine or special-purpose computer, configured to perform the tasks described herein.

### Reconciling the First and Second Data Records

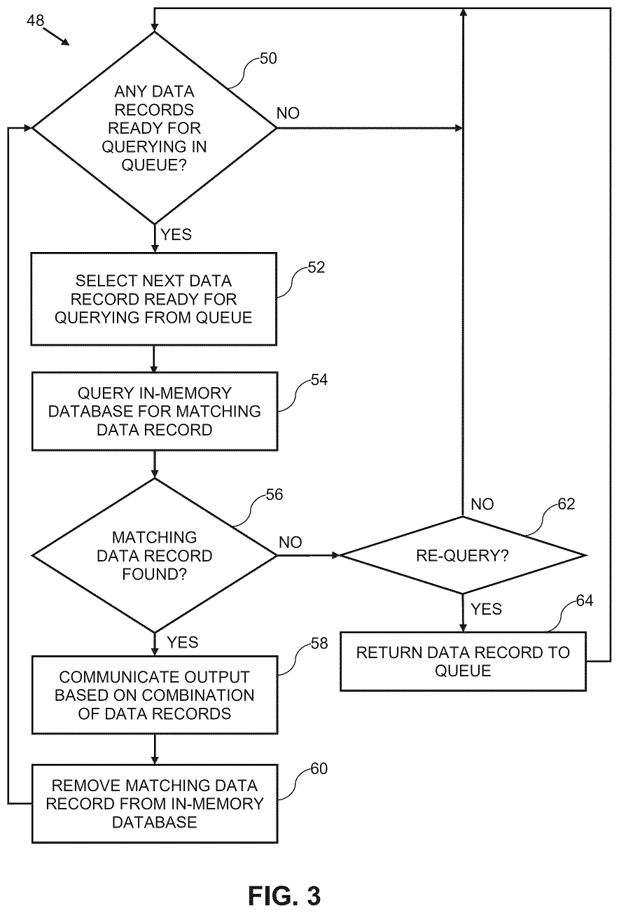

Reference is now made to FIG. 2, which is a flow diagram for a method 38 for real-time reconciliation of data records from multiple data sources, which is performed by processor 30 in accordance with some embodiments of the present invention. Reference is also made to FIG. 3, which is a flow diagram for a method 48 for real-time reconciliation of data records from multiple data sources, which is performed by processor 30 in parallel with method 38 in accordance with some embodiments of the present invention.

In performing method 38 and method 48, the processor receives the first stream of first data records from the first data source and the second stream of second data records from the second data source, as described above with reference to FIG. 1. In response to receiving each of the first data records, the processor stores the first data record in in-memory database 36 (FIG. 1), which associates a timestamp (typically, the time at which the data record is stored) with the data record. In response to receiving each of the second data records, the processor queries the in-memory database for a matching first data record that likely describes the same event 23 (FIG. 1) as does the second data record.

For example, in some embodiments, in performing method 38, the processor checks repeatedly, at a checking step 40, whether a data record was received. If yes, the processor checks, at another checking step 42, whether the data record is from the first data source. If yes, the processor stores the data record in the in-memory database, at a storing step 44. Otherwise (i.e., if the data record is from the second data source), the processor, at a queuing step 46, places the data record in a querying queue. (In this context, the term “queue” should be interpreted broadly as encompassing any suitable type of data structure that allows storage and retrieval of the data records as described herein.) Following storing step 44 or queuing step 46, the processor returns to checking step 40.

In some embodiments, prior to storing the data record in the in-memory database at storing step 44, the processor checks if the data record is a duplicate of another data record already stored in the in-memory database. If yes, the processor refrains from storing the newer duplicate, or replaces the older duplicate with the newer duplicate.

Alternatively or additionally, in some embodiments, in performing method 48, the processor repeatedly checks, at a checking step 50, whether the querying queue contains any data records ready for querying. A data record is considered ready for querying if a query has not yet been performed for the data record, or if a predefined duration (or “waiting period”) following the most recent query performed for the data record has passed. Provided the queue contains at least one data record ready for querying, such a data record is selected from the queue at a selecting step 52. As noted above, the selected data record is from the second data source, and is hence referred to as a second data record.

Next, the processor queries the in-memory database for a matching first data record at a querying step 54. Typically, two conditions must be satisfied for a match to be found.

The first condition is that the timestamp of the matching first data record-which, as noted above, is typically the time at which the first data record was stored in the database, which is almost identical to the time at which the first data record was received-is later than a predefined threshold time. In general, the first condition is based on the assumption that two data records that describe the same event will be generated (and hence, received) relatively close to one another in time.

In some embodiments, the processor defines the threshold time as t - s, t being the current time (i.e., the time at which the in-memory database is queried for the matching first data record), and s being a variable that can be set to any suitable number of seconds or milliseconds, e.g., depending on the expected latency between the first and second data streams. In other embodiments, the processor defines the threshold time based on a time contained in the second data record, such as the time at which the second data record was recorded.

The second condition is that at least some of the corresponding second values in the second data record match the corresponding first values in the matching first data record. In some embodiments, the values that must match, per this condition, is determined by a variable having different settings. In other words, the processor queries the in-memory database based on a variable having different settings indicating which of the corresponding second values in the second data record need to match the corresponding first values in the matching first data record. For example, for credit-card transactions, one setting of the variable may require only that both data records include the same first N digits and/or last M digits of the credit card, the same transaction currency, and the same transaction amount, whereas another setting of the variable may also require a match for additional corresponding values. Advantageously, the different settings allow customization to a variety of applications.

It is noted that the second condition is not sufficient, given that it is possible for two different events to match with respect to the corresponding values. For example, two different credit-card transactions with the same credit card and in the same currency may coincidentally have the same amount, two different credit cards may coincidentally share the same first N digits and/or last M digits, or two different possible cybersecurity breaches may be associated with the same devices. The first condition compensates for this deficiency, given that it is highly improbable, i.e., virtually impossible, for two such similar events to occur very close in time to one another.

In some cases, corresponding values are represented differently by the two data sources. To address this challenge, in some embodiments, the processor is configured to map corresponding values to one another. In other words, the processor changes the representation of the relevant first value(s) prior to storing each first data record in the in-memory database, or changes the representation of the relevant second value(s) prior to querying for a match for each second data record, such that the corresponding values have the same representation.

For example, whereas data records from merchants may include the original digits of credit card numbers, data records from financial institutions may include tokenized digits. To address this challenge, the processor may receive mappings between the original digits and the tokenized digits from the financial institutions, and apply the mappings to either the original digits or the tokenized digits. As another example, different cybersecurity services may include different device IDs for the same device. To address this challenge, the processor may receive mappings between device IDs from one of the services, and apply the mappings to either the device IDs in the first data records or the device IDs in the second data records. As another example, the two data sources may format corresponding values differently, e.g., using different characters or different numbers of white spaces between segments of a value. To address this challenge, the processor may reformat the relevant values in the first or second data records such that the formatting is consistent between the first and second data records.

In view of the above, it is noted that in the context of the present application, including the claims, corresponding first and second values are said to match one another even if the two values are represented differently in the original data records, provided there exists a predefined mapping that maps one representation to the other representation.

Following querying step 54, the processor checks, at a checking step 56, whether a matching data record was found. If yes, the processor, at a communicating step 58, communicates an output based on a combination of the second values in the second data record with the first values in the matching first data record. In some embodiments, the output is communicated to the first data source and/or to the second data source. Alternatively or additionally, the output is communicated to any other suitable destination.

In some embodiments, the output includes an enriched data record combining the second values in the second data record with the first values in the matching first data record. Alternatively or additionally, the output includes a recommended action in response to the event based on which the second data record and the matching first data record were likely generated. For example, the recommended action may include approving or denying a credit-card transaction, or executing a cybersecurity process (e.g., locking a computer or quarantining a file).

Typically, following communicating step 58, the processor removes the matching data record from the in-memory database at a removing step 60, thereby preventing the data record from needlessly slowing subsequent queries and/or from being returned, in response to a subsequent query, as a false match. The processor then returns to checking step 50.

On the other hand, if a matching data record is not found, the processor decides, at a deciding step 62, whether to re-query the in-memory database for the matching first data record after a predefined waiting period w, which was introduced above with reference to checking step 50. Typically, deciding step 62 is based on a predefined maximum delay D, which is the maximum acceptable delay for returning a matching first data record. In particular, indicating the receipt time of the second data record by t0 and the current time (i.e., the time at which deciding step 62 is performed) as t, the processor decides to re-query the database only if t+w≤t0+D. Alternatively, a maximum number of re-queries is predefined based on w and D, and the processor decides to re-query the database only if the maximum number of re-queries has not yet been reached. Thus, the processor balances the two competing objectives of (i) finding as many matches as possible, and (ii) achieving real-time reconciliation.

Typically, the processor sets w so as to expedite the retrieval of a match without needlessly tying up computing resources. For example, in some embodiments, w is set to a value between 10 and 50 ms. Alternatively or additionally, the processor sets D (and hence, the maximum number of re-queries for the matching first data record) as a decreasing function of the geographic distance between the processor and the destination to which the output is communicated. The reason for this is that for smaller distances, it takes less time for the output to reach the destination, and hence, the processor can allow a larger D (and hence, a greater number of re-queries), whereas for larger distances, the processor must reduce D to allow the output to be received in real-time. For example, given a service agreement that allows a maximum latency of L for receipt of the output (i.e., that effectively defines “real-time” as a latency no greater than L, which in some embodiments is between 100 and 500 ms), the processor may set D as L−f(d), where d is the distance between the processor and the destination and f(d) is an increasing function of d. In some embodiments, f is also a function of one or more other parameters that affect the time required for the output to reach the destination, such as the amount of traffic on the network.

For example, it will be supposed that L=200 ms and that deciding step 62 is reached, for the first time, 50 ms after receipt of the second data record. If f(d)=20 ms, there would be 130 ms available for re-queries. Thus, for example, the processor could decide to perform a maximum of four re-queries with w=30 ms or eight re-queries with w=15 ms. As another example, if f(d)=100 ms, the processor could decide to perform a maximum of two re-queries with w=25 ms or five re-queries with w=10 ms.

In response to deciding to re-query the in-memory database, the processor returns the second data record to the queue at a returning step 64. Subsequently, or if the processor decides not to re-query, the processor returns to checking step 50.

In some embodiments, if the querying returns multiple matching first data records, the processor refrains from communicating the output and, typically, no re-querying is performed. Alternatively, the processor communicates the output even if multiple matches are found, by selecting one of the matching data records for combination with the second data record.

In some embodiments, for each first data record, the processor queries another data source for additional data related to the existing data in the first data record. In response to receiving the additional data, the processor enriches the first data record-which typically, in the meantime, has been stored in the in-memory database—with the additional data. Typically, in such embodiments, if a first data record that has not yet been enriched is returned as a match, the processor refrains from communicating the output until the first data record has been enriched or the time limit of t0+D has been reached.

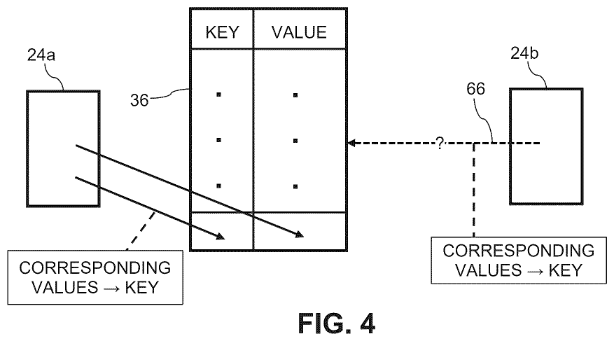

Reference is now made to FIG. 4, which is a schematic illustration of in-memory database 36 in use, in accordance with some embodiments of the present invention.

Typically, in-memory database 36 includes a key-value database, which advantageously facilitates fast querying, thereby facilitating real-time reconciliation of first data records 24a with second data records 24b. In some such embodiments, the key-value database includes a sorted set in which the first data records are sorted by their timestamps and data records with equivalent timestamps are sorted lexicographically, by key.

In such embodiments, for each received first data record 24a, the processor (e.g., at storing step 44 (FIG. 2)) computes a first key from the corresponding values in the first data record, e.g., by concatenating the corresponding values. As described above with reference to FIG. 1, the corresponding values are those that describe the same type of data as corresponding values in the second data record. For example, for embodiments in which each data record describes a credit-card transaction, the corresponding values may include the first N digits and/or the last M digits of the credit card (e.g., “1234”), the currency of the transaction (e.g., “USD”), and/or the amount of the transaction (e.g., “10.99”), such that, assuming the key is computed by concatenating the corresponding values, the key may be “1234USD10.99.” Following the computation of the first key, at least some of the first values (e.g., all the first values, or all the first values aside from the corresponding values) in the first data record are stored, in association with the first key, in the key-value database.

Similarly, for each received second data record 24b, the processor (e.g., at querying step 54 (FIG. 3)) computes a second key from the corresponding second values in the second data record, using the same function used to compute the first keys. The processor then queries the key-value database for the second key, as indicated in FIG. 4 by a query indicator 66. As described above with reference to FIG. 3, the query additionally includes a condition on the timestamp.

Typically, regardless of whether the in-memory database includes a key-value database, any first data record that has been in the database for longer than a predefined amount of time is removed from the database, such that the querying remains fast and such that the chance of a query returning multiple results is reduced. For example, in some embodiments, the processor periodically purges the database of old data records.

It will be appreciated by persons skilled in the art that the present invention is not limited to what has been particularly shown and described hereinabove. Rather, the scope of the present invention includes both combinations and subcombinations of the various features described hereinabove, as well as variations and modifications thereof that are not in the prior art, which would occur to persons skilled in the art upon reading the foregoing description.

1. A method for use with a first data source that generates a first stream of first data records, each of which includes one or more first values describing a respective one of multiple events, and a second data source that generates a second stream of second data records, each of which includes one or more second values describing a respective one of the events, at least some of the second values corresponding to corresponding ones of the first values by virtue of describing the same type of data as do the corresponding ones of the first values, the method comprising:
receiving, by a processor, the first stream of first data records from the first data source and the second stream of second data records from the second data source;
in response to receiving each of the first data records, storing the first data record in an in-memory database that associates a timestamp with the first data record;
in response to receiving each of the second data records, querying the in-memory database for a matching first data record that likely describes the same one of the events as does the second data record, by virtue of:
the timestamp of the matching first data record being later than a predefined threshold time, and
at least some of the corresponding second values in the second data record matching the corresponding ones of the first values in the matching first data record; and
provided the querying returns the matching first data record, communicating an output based on a combination of the second values in the second data record with the first values in the matching first data record.

2. The method according to claim 1, wherein querying the in-memory database comprises querying the in-memory database based on a variable having different settings indicating which of the corresponding second values in the second data record need to match the corresponding ones of the first values in the matching first data record.

3. The method according to claim 1, wherein the predefined threshold time is t - s, t being a time at which the in-memory database is queried for the matching first data record, and s being a variable.

4. The method according to claim 1, wherein the output includes a recommended action in response to the event based on which the second data record and the matching first data record were likely generated.

5. The method according to claim 1, wherein communicating the output comprises communicating the output to the first data source and/or to the second data source.

6. The method according to claim 1, wherein the output includes an enriched data record combining the second values in the second data record with the first values in the matching first data record.

7. The method according to claim 1,
wherein the in-memory database includes a key-value database,
wherein storing the first data record in the in-memory database comprises:
computing a first key from the corresponding ones of the first values in the first data record; and
storing at least some of the first values in the first data record, in association with the first key, in the key-value database, and
wherein querying the in-memory database comprises:
computing a second key from the corresponding second values in the second data record; and
querying the key-value database for the second key.

8. The method according to claim 7, wherein the key-value database includes a sorted set in which the first data records are sorted by the timestamp.

9. The method according to claim 1, further comprising, in response to the querying returning multiple matching first data records, refraining from communicating the output.

10. The method according to claim 1, further comprising, in response to the querying not returning the matching first data record, re-querying the in-memory database for the matching first data record, at least once, after a predefined duration.

11. The method according to claim 10, further comprising setting a maximum number of re-queries for the matching first data record as a decreasing function of a geographic distance between the processor and a destination to which the output is communicated.

12. A computer software product for use with a first data source that generates a first stream of first data records, each of which includes one or more first values describing a respective one of multiple events, and a second data source that generates a second stream of second data records, each of which includes one or more second values describing a respective one of the events, at least some of the second values corresponding to corresponding ones of the first values by virtue of describing the same type of data as do the corresponding ones of the first values, the computer software product comprising a tangible non-transitory computer-readable medium in which program instructions are stored, which instructions, when read by a processor, cause the processor to:
receive the first stream of first data records from the first data source and the second stream of second data records from the second data source,
in response to receiving each of the first data records, store the first data record in an in-memory database that associates a timestamp with the first data record,
in response to receiving each of the second data records, query the in-memory database for a matching first data record that likely describes the same one of the events as does the second data record, by virtue of:
the timestamp of the matching first data record being later than a predefined threshold time, and
at least some of the corresponding second values in the second data record matching the corresponding ones of the first values in the matching first data record, and
provided the querying returns the matching first data record, communicate an output based on a combination of the second values in the second data record with the first values in the matching first data record.

13. The computer software product according to claim 12, wherein the instructions cause the processor to query the in-memory database based on a variable having different settings indicating which of the corresponding second values in the second data record need to match the corresponding ones of the first values in the matching first data record.

14. The computer software product according to claim 12, wherein the instructions cause the processor to define the predefined threshold time as t - s, t being a time at which the in-memory database is queried for the matching first data record, and s being a variable.

15. The computer software product according to claim 12, wherein the output includes a recommended action in response to the event based on which the second data record and the matching first data record were likely generated.

16. The computer software product according to claim 12, wherein the output includes an enriched data record combining the second values in the second data record with the first values in the matching first data record.

17. The computer software product according to claim 12,
wherein the in-memory database includes a key-value database,
wherein the instructions cause the processor to store the first data record in the in-memory database by:
computing a first key from the corresponding ones of the first values in the first data record, and
storing at least some of the first values in the first data record, in association with the first key, in the key-value database, and
wherein the instructions cause the processor to query the in-memory database by:
computing a second key from the corresponding second values in the second data record, and
querying the key-value database for the second key.

18. The computer software product according to claim 17, wherein the key-value database includes a sorted set in which the first data records are sorted by the timestamp.

19. The computer software product according to claim 12, wherein the instructions cause the processor to, in response to the querying not returning the matching first data record, re-query the in-memory database for the matching first data record, at least once, after a predefined duration.

20. A system for use with a first data source that generates a first stream of first data records, each of which includes one or more first values describing a respective one of multiple events, and a second data source that generates a second stream of second data records, each of which includes one or more second values describing a respective one of the events, at least some of the second values corresponding to corresponding ones of the first values by virtue of describing the same type of data as do the corresponding ones of the first values, the system comprising:
a communication interface; and
a processor, configured to:
receive, via the communication interface, the first stream of first data records from the first data source and the second stream of second data records from the second data source,
in response to receiving each of the first data records, store the first data record in an in-memory database that associates a timestamp with the first data record,
in response to receiving each of the second data records, query the in-memory database for a matching first data record that likely describes the same one of the events as does the second data record, by virtue of:
the timestamp of the matching first data record being later than a predefined threshold time, and
at least some of the corresponding second values in the second data record matching the corresponding ones of the first values in the matching first data record, and provided the querying returns the matching first data record, communicate an output based on a combination of the second values in the second data record with the first values in the matching first data record.
